(19) United States
(12) Patent Application Publication
(10) Pub. No.: US 2006/0228535 A1
(43) Pub. Date: Oct. 12, 2006

(54) Composite materials and extruded profiles containing mill feed

(76) Inventors: Li Nie, Parkville, MO (US); Sukh D. Bassi, Atchison, KS (US); Clodualdo C. Maningat, Platte City, MO (US)

Correspondence Address: LATHROP & GAGE LC, 4845 PEARL EAST CIRCLE, SUITE 300, BOULDER, CO, 80301, US

(21) Appl. No.: 11/384,151

(22) Filed: Mar. 17, 2006

Related U.S. Application Data
(60) Provisional application No. 60/662,706, filed on Mar. 17, 2005.

(51) Int. Cl. B41M 3/10

(52) U.S. Cl. 428/211.1

(57) ABSTRACT

Composite materials containing mill feeds and a synthetic resin, such as polyethylene and/or polypropylene, may be used to make wood replacement products for use as construction materials.

### RELATED APPLICATIONS

This application claims priority to U.S. Application No. 60/662,706, filed Mar. 17, 2005, which is incorporated herein by reference.

### BACKGROUND

1. Field of the Invention

The present invention pertains to the field of composite materials and, more particularly, to composites containing mill feed mixed with a plastic resin or the like. The composites may be shaped into products for use in the construction industry, such as artificial boards or panels that may optionally be embossed to provide a wood grain texture.

2. Description of the Related Art

Wood-plastic composites are widely used in residential and commercial structures for decking board, fencing, railing and so forth. In the manufacture of these products, wood flour or wood fiber is mixed with a resin and the composite is extruded. Warm extruded profiles may be embossed to create a real wood or wood grain appearance.

Initially, these products represented a marked cost savings over actual wood when used for the same purposes. Over time, however, the cost of wood flour and wood fiber has increased dramatically. A decade ago, wood flour and wood fiber were little-used by-products of the paper and lumber industries. Today, the opposite is true; trees are grown for the specific purpose of direct conversion into wood flour or wood fiber for use in wood-plastic composites.

In addition to increasing formulation costs, wood-plastic composites have several drawbacks. For example, expensive lubricants are required during profile extrusion to achieve a smooth surface finish, and finished products usually have a strong wood color. Lightly colored, or white, products may be produced if significant amounts of titanium dioxide are added to a resin formulation, but darker products tend to fade with sun exposure. Wood flour and wood fiber products are also susceptible to water damage because the filler materials readily adsorb moisture.

Alternatives to Wood Flour and Wood Fiber

In an attempt to replace wood flour and wood fiber in composites, various materials have been used. For example, formulations containing sand, clay, mica and other inorganic compounds are known. These materials may, however, garner higher prices in other industries, such as construction (e.g., cement) and bioremediation. It is also noted that the mining or excavation of these materials is costly and environmentally controversial.

In terms of renewable plant materials, starch, which is derived from cereal grain seeds, has been used as a binder to create biodegradable composite products. However, starch tends to retrograde when exposed to moisture, creating brittle final products with less than ideal mechanical properties.

Cereal Grains

Cereal grain seeds contain a leaf-like outer covering, such as a husk, hull or chaff, that is separated from the seed during harvesting or processing. The seed itself contains an outer wall called bran, an embryo called germ, and an energy store called endosperm that makes up the majority of the seed (˜82% by weight) and consists of approximately 70% starch. Milling of grain removes the bran and germ from the endosperm, which is sold independently as refined flour. The remaining bran (˜12-15% by weight) and germ (˜3-5% by weight), together with a small, unrecoverable portion of endosperm (˜9% by weight), make up the bran rich fraction obtained from grain milling, which is sometimes referred to as mill feed. Bran contains large amounts of fiber in the form of water-insoluble and highly recalcitrant cellulose, hemicellulose and lignin. These fibrous materials cannot be digested by humans, and are susceptible to relatively few organisms and enzymes in nature. This property helps to distinguish bran from the readily biodegradable starch fraction of grain. Germ contains proteins and fats.

### SUMMARY

The present instrumentalities advance the art and overcome the problems that are outlined above.

In one aspect, a manufactured product for use as a wood substitute, includes: from 20% to 80% by weight mill feed; from 20-78% by weight of a synthetic resin; from 0.5-5% by weight compatibilizer; and from 0% to 10% by weight fibers.

In one aspect, a composition suitable for use as a wood substitute, includes from 20% to 80% by weight mill feed and from 20-78% by weight of a synthetic resin.

In another aspect, a method of making a substitute wood product includes the steps of combining ingredients including: from 20% to 80% by weight mill feed, from 20-78% by weight of a synthetic resin, from 0.5-5% by weight compatibilizer, and from 0% to 15% by weight fibers; processing the ingredients to achieve a melt temperature of the synthetic resin; and extrusion shaping the substitute wood product.

### DETAILED DESCRIPTION

Native and/or modified mill feeds, such as corn mill feed, wheat mill feed, barley mill feed and/or milo mill feed are inexpensive by-products of flour production. Additionally, soybeans, mung beans and quinoa, which are not technically cereal grains, may be used as a filler according to the present teachings. Thus, the term “mill feed” encompasses starch-depleted fractions of cereal grains, pseudo-grain crops and legume seeds.

Mill feeds make an ideal filler source for use in filled composite boards. Mill feed is economical and gives a natural color to composites.

There is a wax coating on the mill feed that acts as a lubricant during profile extrusion, and composite boards made from mill feed are notably hydrophobic, a result of the hydrophobic properties of the mill feed itself. This is an advantageous property where the composite board is to be left outside or used in an environment having high humidity.

It has further been found that mill feed imparts a biocidal property to the composite board of which it is a part. A biocide, an agent that repels or kills insects and other pests, is present in some seeds. For example, the outer part of quinoa is coated with saponin, a sticky, bitter-tasting substance that acts as a natural insect repellent. The biocidal effect of mill feed may, for example, protect the final product from insects and pests, such as termites and wood-boring bees.

The use of mill feed as a filler helps reduce formulation costs and improves modulus and dimensional stability. Mill feed fillers generally improve nailing and sawing qualities of the composite boards. Mill feed as a filler does not have as good a reinforcing effect as fibers for flex modulus. Thus, adding a small amount of fiber helps overcome this problem in some embodiments. The disclosed formulations may, for example, include fibers selected from the group consisting of glass fibers, cotton, hardwood fibers, softwood fibers, flax, abaca, sisal, ramie, hemp, jute, bagasse, kenaf, recycled paper fibers, cellulose fibers, polymer fibers, and mixtures thereof.

Resins for use in the disclosed formulations include those selected from the group consisting of polyolefines, polyethylene, polypropylene, polyurethane, polystyrene, polyamides, polyesters, and combinations thereof. It will be appreciated that combinations of polymers may include both physical mixtures and chemical combinations, e.g., block-copolymers.

As noted above, mill feed for use in the present formulations may be derived from various sources including, modified and unmodified corn, wheat, milo soybean, mung bean, barley, and quinoa. Mill feed used in the composites disclosed herein may be of any particle size that imparts desirable chemical and physical stability to the final extruded profile. In one embodiment, preferred mill feed particle sizes are smaller than 149 μm. For example, mill feed may be between between 149-105 μm. In another embodiment, a mill feed particle size less than about 125 μm is used.

Compatibilizers suitable for incorporation into the present formulations include maleic anhydride grafted polymers, also known as maleated polymers. Preferred compatibilizers include maleated polyethylene and maleated polypropylene. A compatibilizer is generally an amphiphilic component that helps to promote and maintain intimate contact between polar and non-polar components in a mixture.

Lubricants suitable for use in the present formulations include fatty acid esters, glycerol monostearate, glycerol distearate, sodium stearate, potassium stearate and other non-metallic fatty acid compounds known in the art.

Generally speaking, composite resins described herein have bulk densities in the range of 20-45 lbs/ft³. The density of an extrusion profile made from one of these resins may be controlled to fall within a range of 0.7-1.2 g/cm³.

The following examples teach by way of illustration, and not by limitation, to illustrate preferred embodiments of what is claimed.

### EXAMPLE 1

### Formulations for Mill Feed-Polyethylene Composites

Composite Resin Formulation:

| | | |
|---|---|---|
| Wheat mill feed (containing wheat germ) | 60 | parts |
| High density polyethylene (1.2 melt index) | 37.5 | parts |
| Polybond ® 3109 (compatibilizer)* | 2.5 | parts |

*Polybond ® is a registered trademark of Chemtura Corporation, Middlebury, CT. Polybond ® 3109 is a maleic anhydride grafted linear low density polyethylene.

The composite resin described above is produced in a Berstorff UTX-75A twin screw extruder at a rate of 1800 lbs/hr. The wheat mill feed is dried to a moisture content of 3.5% or less using a flash tube dryer, and then fed into the extruder barrel through a side feeder. Venting ports and a vacuum stuffer are available on the extruder barrel to reduce moisture and control the melt temperature (in addition to other barrel temperature controls). The resulting pellets are cut with a Gala underwater system. The final moisture content of the pellets is controlled to less than 1.0%.

The above-described resin pellets can be used for making profile extruded fencing boards with a die dimension of ⅝″× 58/8″ on a single screw extruder (3.5″ Prodex) using the following formulation:

| | |
|---|---|
| Pellets (as above) | 98% |
| TWP 113 (lubricant) | 2.0% |

The extruder barrel temperature is set at 265° F. The melt profile passes through a profile shape into a water spray chamber for slow surface cooling, and is then subjected to a heated embossing roll that imparts wood grain texture or other surface patterns. After embossing, the profile board is cut with a flying saw. The final product has excellent white coloring.

### EXAMPLE 2

### Mill Feed-Polyethylene Direct Profile Extrusion

Composite Resin Formulation:

| | |
|---|---|
| Wheat mill feed | 55% |
| Cellulose fiber | 5% |
| High density polyethylene (0.5 melt index) | 34% |
| Polybond ® 3109 (compatibilizer) | 2.5% |
| Talc | 2% |
| TPW 113 (lubricant) | 1.5% |

Polyethylene, Polybond® 3109, talc, and TPW 113 are fed to the main feeding hopper of a ZE75A-UTX twin screw extruder. The plastic pellets are melted in the plasticating zone and mixed with other ingredients. The extruder barrel temperature at the die end is set at 280° F. Predried wheat mill feed and cellulose are fed to the extruder barrel by a side feeder. Venting ports and a vacuum stuffer are available on the extruder barrel to reduce moisture and control the melt temperature (in addition to other barrel temperature controls). The total rate of production is set at 1800 lbs/hr.

The melt passes through a profile shape for standard decking board into a water spray chamber for slow surface cooling, and is then subjected to a heated embossing roll that imparts wood grain texture or other surface patterns. After embossing, the profile board is cut with a flying saw. The final product has excellent white coloring.

### EXAMPLE 3

### Processing of Composites

Commercially available mill feed may be pre-dried in a flash tube dryer or tornesh dryer to a moisture content of 1-5%. Resins, together with some additives, are fed into the main extrusion hopper and melted in the plasticating zone. The filler, together with some additives, is fed with a side feeder after the resins have melted. The screws mix the filler, plastics and other minor ingredients. Venting ports are provided to release air and moisture in the melt. A down-stream venting port is provided with a vacuum stuffer.

For composite pellets, one may use die face pelleting, an underwater pelleting system, or a melt sheet dicer system depending on the formulation. The pellets may be dried or cooled to a moisture content of less than 1% before final packaging.

For profiles, melt flows out of a shaping die. The processing temperature for the melt is controlled from 260-380° F. for polyethylene composites and from 320-420° F. for polypropylene composites. The melt profile is cooled with calibration for shape size control. The hot profiles are further cooled with water cooling tanks or with water spray. After proper cooling, the profiles can be embossed with embossing rolls. After cutting with a synchronized sawing table, the profiles are cooled further on a cooling tower or table for final dimensional stability control.

Twin-screw compounders are used for making composite pellets. Twin-screw extruders are also used for direct profile extrusion, without an intermediate step of forming composite pellets. Both twin-screw and single-screw extruders are used for making profiles. Single-screw extruders are often used when composite pellets are the main feed.

Changes may be made in the above systems and methods without departing from the subject matter described in the Summary and defined by the following claims. It should thus be noted that the matter contained in the above description should be interpreted as illustrative and not limiting.

All references cited are incorporated by reference herein.

What is claimed:

1. A manufactured product for use as a wood substitute, comprising:
from 20% to 80% by weight mill feed;
from 20-78% by weight of a synthetic resin;
from 0.5-5% by weight compatibilizer; and
from 0% to 15% by weight fibers.

2. The manufactured product of claim 1 having an artificial wood grain texture.

3. The manufactured product of claim 1, wherein the synthetic resin is selected from the group consisting of polyolefines, polyethylene, polypropylene, polyurethane, polystyrene, polyamides, polyesters, and combinations thereof.

4. The manufactured product of claim 1, wherein the fibers are selected from the group consisting of glass fibers, cotton, hardwood fibers, softwood fibers, flax, abaca, sisal, ramie, hemp, jute, bagasse, kenaf, recycled paper fibers, cellulose fibers, polymer fibers, and mixtures thereof.

5. The manufactured product of claim 1, wherein the mill feed source is selected from the group consisting of corn, wheat, milo, soybean, mung bean, barley and quinoa.

6. The manufactured product of claim 1, wherein the product produces a biocidal effect.

7. The manufactured product of claim 1, wherein the mill feed has a particle size less than 149 μm.

8. The manufactured product of claim 1, wherein the mill feed has a particle size between between 149-105 μm.

9. The manufactured product of claim 1, wherein the mill feed has a particle sizeless than 125 μm.

10. The manufactured product of claim 1, further comprising a lubricant selected from the group consisting of fatty acid esters, glycerol monostearate, glycerol distearate, sodium stearate, potassium stearate and combinations thereof.

11. The manufactured product of claim 1, wherein the compatibilizer is selected from the group consisting of maleated polyethylene, maleated polypropylene and mixtures thereof.

12. The manufactured product of claim 1, wherein the product has a density in a range between 0.7-1.2 g/cm³.

13. A composition suitable for use as a wood substitute, comprising:
from 20% to 80% by weight mill feed; and
from 20-78% by weight of a synthetic resin.

14. The composition of claim 13, further comprising from 0.5-5% by weight compatibilizer.

15. The composition of claim 14, wherein the compatibilizer is selected from the group consisting of maleated polyethylene, maleated polypropylene and mixtures thereof.

16. The composition of claim 13, further comprising from 0% to 15% by weight fibers.

17. The composition of claim 16, wherein the fibers are selected from the group consisting of glass fibers, cotton, hardwood fibers, softwood fibers, flax, abaca, sisal, ramie, hemp, jute, bagasse, kenaf, recycled paper fibers, cellulose fibers, polymer fibers, and mixtures thereof.

18. The composition of claim 13, wherein the synthetic resin is selected from the group consisting of polyolefines, polyethylene, polypropylene, polyurethane, polystyrene, polyamides, polyesters, and combinations thereof.

19. The composition of claim 13, wherein the mill feed source is selected from the group consisting of corn, wheat, milo, soybean, mung bean, barley and quinoa.

20. The composition of claim 13, wherein the mill feed has a particle size less than 149 μm.

21. The composition of claim 13, wherein the composition has a bulk density in the range between 20-45 lbs/ft³.

22. A method of making a substitute wood product, the method comprising the steps of:
combining ingredients including:
from 20% to 80% by weight mill feed,
from 20-78% by weight of a synthetic resin,
from 0.5-5% by weight compatibilizer, and
from 0% to 15% by weight fibers;
processing the ingredients to achieve a melt temperature of the synthetic resin; and
extrusion shaping the substitute wood product.
